(19) United States
(12) Patent Application Publication
(10) Pub. No.: US 2007/0152906 A1
(43) Pub. Date: Jul. 5, 2007

(54) STRUCTURE OF ANTENNA CONNECTOR

(75) Inventor: HSI-CHUAN WONG, BANCIAO (TW)

Correspondence Address: T-CONN PRECISION CORPORATION, 4F-18, NO. 121, SEC. 1, CHONG QING SOUTH ROAD, TAIPEI, 100, TW

(73) Assignee: T-CONN PRECISION CORPORATION, BANCIAO (TW)

(21) Appl. No.: 11/307,508

(22) Filed: Feb. 10, 2006

(30) Foreign Application Priority Data
Dec. 30, 2005 (TW) 094223200

(51) Int. Cl. H01Q 1/50

(52) U.S. Cl. 343/906; 343/702

(57) ABSTRACT

A structure of an antenna connector is provided. The antenna connector comprises a metal plate and an isolation member. The metal plate comprises at least a terminal, two wing boards and a clamp, wherein the terminal is located between the two wing boards and the clamp is located below the terminal. The isolation member comprises a sleeve located at a position corresponding to the terminal of the metal plate and two fixing portions located at positions corresponding to the two wing boards. The two fixing portions comprise a plurality of slots for fixing the wind boards. To assemble the isolation member to the metal plate, the isolation member is placed over the metal plate such that the terminal is received within the sleeve of the isolation member and the two wing boards are fixed into the slots of the two fixing portions respectively.

This application claims the priority benefit of a Taiwan patent application No. 094223200 filed on Dec. 30, 2005.

### FIELD OF THE INVENTION

The present invention generally relates to a structure of an antenna connector, and more particularly to a structure of antenna connector, wherein the metal plate and the isolation member may be assembled by a simple assembly process and the cable may be securely fixed to the antenna connector so as to not to easily come loose from the antenna connector. The fabrication yield and the reliability of the antenna connector may be effectively promoted.

### DESCRIPTION OF RELATED ART

Assembly of a conventional antenna connector is usually accomplished manually, wherein the terminals are assembled on an insulated housing by hand, and then a metal housing is covered on the insulated housing is covered by hand. Finally, a coaxial line is inserted through one end of metal housing by hand, and then the coaxial line is electrically connected to the terminals and secured again by hand.

However, because the size of the connector is small and therefore assembly by hand is not only time consuming but also the error rate is high, such as electrical connection of the coaxial cable to the terminals may not be secure enough or the coaxial cable may be properly secured to the housing and may come loose. Thus, both the production yield and production throughput are reduced. Therefore, the abovementioned method of fabricating the antenna connector is not practical.

### SUMMARY OF THE INVENTION

Accordingly, the present invention is directed to securely clip the cable the antenna connector such that the cable does not easily come loose. Thus, the fabrication yield and the reliability of the antenna connector can be effectively promoted.

According to an aspect of the present invention, the assembly of the metal plate, the isolation member and the cable may be carried out on an automatic workstation so as to eliminate time consuming and laborious manual assembly process may be effectively eliminated. Thus, the fabrication yield, the fabrication throughput and the reliability of the antenna connector may be effectively promoted.

In accordance with the above objectives and other objectives of the present invention, a structure of a metal plate and a structure of an isolation member are provided. The metal plate comprises at least a terminal, two wing boards and a clamp, wherein the terminal is located between the two wing boards and the clamp is located below the terminal. The isolation member comprises a sleeve located at a position corresponding to the terminal of the metal plate and two fixing portions located at positions corresponding to the two wing boards. The two fixing portions comprise a plurality of slots for fixing the wind boards. To assemble the isolation member to the metal plate, the isolation member is placed over the metal plate such that the terminal is received within the sleeve of the isolation member and the two wing boards are fixed into the slots of the two fixing portions respectively. The cable may be clamped within the clamp 16 and the conductive wire of the cable may be electrically connected to the terminal.

### BRIEF DESCRIPTION OF THE DRAWINGS

FIG. 1 shows a perspective view of a structure of an antenna connector according to an embodiment of the present invention.

FIG. 2 shows an exploded perspective view of a structure of an antenna connector according to an embodiment of the present invention.

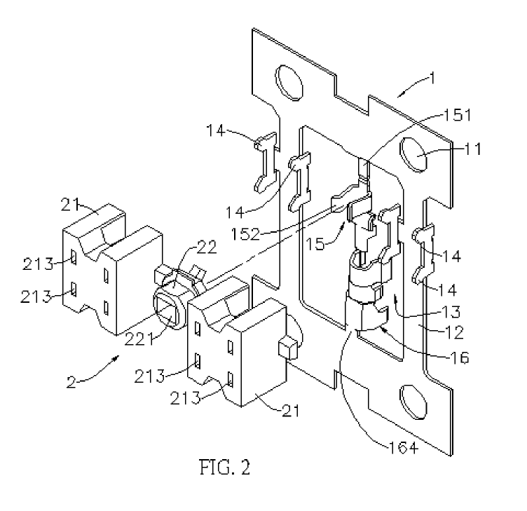

FIG. 3 shows a perspective view of a structure of an antenna connector of the present invention when viewed from another angle.

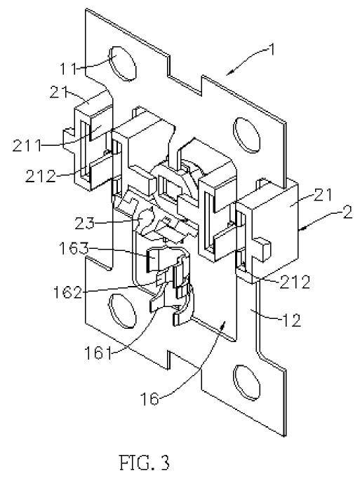

FIG. 4 shows an exploded perspective view of a structure of an antenna connector of the present invention when viewed from another angle.

FIG. 5 shows a perspective view of a structure of an antenna connector after being assembled according to an embodiment of the present invention.

### DETAILED DESCRIPTION OF THE INVENTION

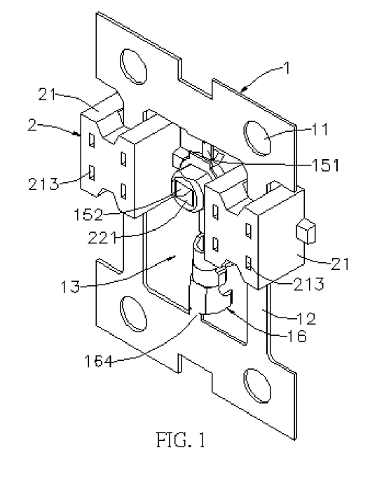

Referring to FIGS. 1˜4, the structure of an antenna connector comprises a metal tape 1 and an isolation member 2. The metal plate 1 and the isolation member 2 may be securely assembled together such that they cannot be easily disengaged from each other. Thus, the fabrication yield, the fabrication throughput and the reliability of the antenna connector may be effectively promoted.

The metal plate comprises a plurality of holes 11, two partitions 12, a terminal 15, two wing boards 14, clamp 16 and openings 13. The holes 11 are disposed on the peripheral region of the metal plate 1 and the partitions 12 define the openings 13. The two wing boards 14 extend via the connecting part 141 of the partitions 12. The terminal 15 is located between the two wing boards 14. The terminal 15 comprises a contact part 152 and a fastening part 153 connected to the contacted part 152. The contacted part 152 and the fastening part 153 are disposed opposed to each other. A clamp 16 is located below the terminal 15 and extends via the connecting part 164 of the metal plate 1. The clamp 16 comprises a first clamping portion 161, a second clamping portion 162 and a third clamping portion 163 that correspond to the fastening part 153 of the terminal 15.

The isolation member 2 comprises a sleeve 22 having an opening 221 located at a position corresponding to the terminal 15 of the metal plate 1, two fixing portions 21 located at positions corresponding to the two wing boards 14. The two fixing portions 21 comprise a plurality of slots 213 for fixing the wind boards 14. The two fixing portions 21 comprise indented portions 211 that correspond to the partitions 12. The sleeve 22 comprises a clamp 23 having a cover 231. A locking member 232 is disposed on the cover 231.

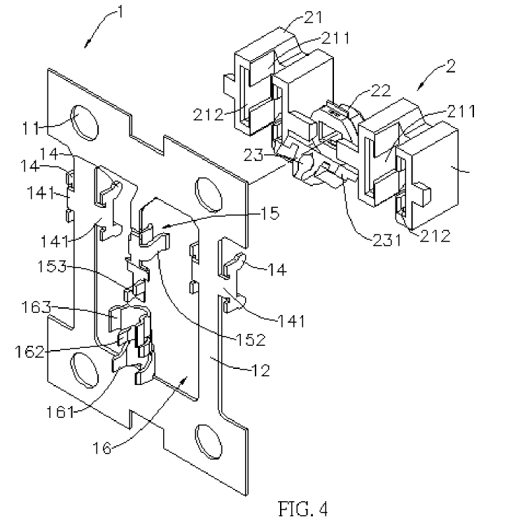

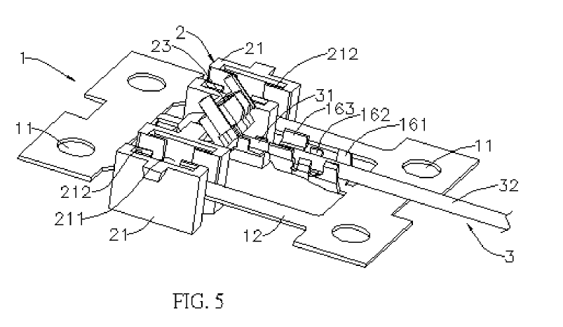

Hereinafter the assembly of the isolation member 2 to the metal plate 1 will be described in detail with reference to FIG. 4 and 5. To assemble the isolation member 2 to the metal plate 1, the isolation member 2 is placed over the metal plate 1 such that the terminal 15 is received within the opening 212 of the sleeve 22 of the isolation member 2 and the two wing boards 14 are fixed into the slots 213 of the two fixing portions 21 respectively such that the partitions 12 are positioned within the indented portions 211 of the fixing portions 21.

A cable 3 covered by a insulating cover 32 may be clamped within the first clamping portion 161, the second clamping portion 162 and the third clamping portion 163 of the clamp 16 and the conductive wire of the cable 3 may be electrically connected to the terminal 15. The cover 231 of the clamp 23 is bent to the backside of the sleeve 22. Next, the locking member 232 is fastened to the fastening part 153 of the terminal 15. Thus, the cable 3 may be securely fixed to the antenna connector and may not be easily come loose. Thus, the fabrication yield and the throughput may be effectively promoted.

Thus, the metal plate and the isolation member may be assembled by a simple assembly process and the cable may be securely fixed to the antenna connector so as to not to easily disengage from the antenna connector. Furthermore, the structure of the metal plate and the isolation member of the present invention described above allow assembly thereof by an automated process. Thus, fabrication yield and the reliability of the antenna connector may be effectively promoted

Although the invention has been explained in relation to its preferred embodiment, it is to be understood that many other possible modifications and variations can be made without departing from the spirit and scope of the invention as hereinafter claimed.

What is claimed is:

1. A structure of an antenna connector, comprising:
a metal plate, a two partitions, a terminal disposed between the two partitions, two wing boards respectively attached the two partitions and a clamp disposed adjacent to the terminal; and
an isolation member, for assembling to the metal plate, comprising two fixing portions, a sleeve disposed between the two fixing portions and a clamp attached to the sleeve, wherein the two fixing portions are adopted for fixing to the two wing boards and the sleeve is adopted for receiving the terminal.

2. The structure of an antenna connector as claimed in claim 1, wherein the plate further comprises a plurality of holes formed on a peripheral region thereof.

3. The structure of an antenna connector as claimed in claim 1, wherein the wing boards comprises indented portion that correspond to the partitions of the metal plate.

4. The structure of an antenna connector as claimed in claim 1, wherein the terminal comprises a contact part and the fastening part.

5. The structure of an antenna connector as claimed in claim 1, wherein the clamp of the metal plate comprises a first clamping portion, a second clamping portion and a third clamping portion.

6. The structure of an antenna connector as claimed in claim 1, wherein the two fixing portions comprise a plurality of slots corresponding to the two wing boards.

7. The structure of an antenna connector as claimed in claim 1, wherein the sleeve comprises an opening.

8. The structure of an antenna connector as claimed in claim 1, wherein the clamp attached to the sleeve of the isolation member comprises a cover connected with a top portion of the sleeve and a fastening part connected to the cover.
